(19) United States
(12) Patent Application Publication
(10) Pub. No.: US 2012/0226566 A1
(43) Pub. Date: Sep. 6, 2012

(54) SCANNER AND SALE DATA PROCESSOR

(75) Inventor: Hiroaki Kato, Mishima-shi (JP)

(73) Assignee: TOSHIBA TEC KABUSHIKI KAISHA, Tokyo (JP)

(21) Appl. No.: 13/406,975

(22) Filed: Feb. 28, 2012

(30) Foreign Application Priority Data
Mar. 2, 2011 (JP) 2011-045511
Dec. 21, 2011 (JP) 2011-280359

(51) Int. Cl. G06K 7/10; G06Q 20/20

(52) U.S. Cl. 705/17; 235/457

(57) ABSTRACT

According to one embodiment, a scanner comprises an image pickup unit, a light source, a control unit, an image capturing unit and an output unit. The light source configured to illuminate the light to an image pickup area of the image pickup unit for pickup the image. The control unit configured to change the illuminating angles of the light illuminated to the image pickup area. The image capturing unit configured to capture the image of the image pickup area by changing the illuminating angles. The output unit configured to output the image with the different illuminating angles captured by the image capturing unit.

### CROSS-REFERENCE TO RELATED APPLICATION

The present application contains subject matter related to that disclosed in Japanese Priority Patent Application JP 2011-045511 filed in the Japan Patent Office on Mar. 2, 2011 and Japanese Priority Patent Application JP 2011-280359 filed in the Japan Patent Office on Dec. 21, 2011, the entire contents of which are hereby incorporated by reference.

### FIELD

Embodiments described herein relate to a scanner and a sale data processor.

### BACKGROUND

At present, a scanner technology is provided such as through image recognition technology by a CCD (Charge Coupled Device) camera read a commodity code and price-cut information from a code symbol such as a barcode or two-dimensional code and the like, or a price-cut label and the like. Generally, a hologram is used for anti-counterfeiting in a credit card, an ID card, a note such as a voucher, a genuine product indication sticker and the like. The ideal circumstance is that authentication of regular commodity is executed through read an image hid in the hologram by the scanner.

Generally, in order to read an image hid in the hologram, an observation angle needs to be adjusted so as to be capable of observing at a proper angle. Furthermore, under the circumstance that the different images are hid in the hologram, the observation angle needs to be changed so that each image stands out from the hologram.

### BRIEF DESCRIPTION OF THE DRAWINGS

FIG. 1 is an outline perspective drawing showing the structure of a checkout lane system of the embodiments.

FIG. 2 is a block diagram showing the hardware structure of a scanner.

FIG. 3 is an explanatory drawing showing illuminating action of a plurality of light sources.

FIG. 4 is an explanatory drawing showing illuminating action of a plurality of light sources.

FIG. 5 is a drawing showing an example of a picked-up image when an imaging subject is illuminated by a light source A.

FIG. 6 is a drawing showing an example of a picked-up image when an imaging subject is illuminated by a light source B.

FIG. 7 is a drawing showing picked-up images of a barcode illuminated by a light source A or a light source B.

FIG. 8 is a block diagram showing the hardware structure of a POS (Point-of-Sale) terminal.

FIG. 9 is a flow chart showing the image capturing and processing sequence executed by a scanner.

FIG. 10 is a flow chart showing the sale registering and processing sequence executed by a POS (Point-of-Sale) terminal.

### DETAILED DESCRIPTION

According to one embodiment, a scanner comprises an image pickup unit, a light source, a control unit, an image capturing unit and an output unit. The light source configured to illuminate the light to an image pickup area of the image pickup unit for pickup the image. The control unit configured to change the illuminating angles of the light illuminated to the image pickup area. The image capturing unit configured to capture the image of the image pickup area by changing the illuminating angles. The output unit configured to output the image with the different illuminating angles captured by the image capturing unit.

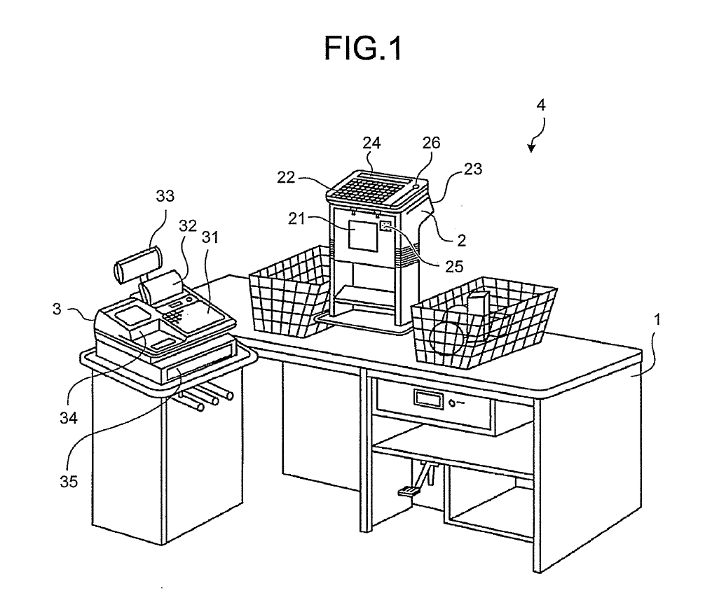

FIG. 1 is an outline perspective drawing showing the structure of a checkout lane system 4 of the embodiments. As showing in FIG. 1, the checkout lane system 4 comprises a bagging table 1 configured to carry a market basket filled with the commodity, a scanner 2 vertically disposed at the center of the bagging table 1 approximately, and a POS terminal 3 (a sale data processor) configured to be connected and communicated with the scanner 2 by a transmission path which is not shown in the figures.

Firstly, the scanner 2 is illustrated. The scanner 2 is configured to read the image of the barcode or the hologram on the commodity and output information contained in the commodity information or the hologram in the barcode to the POS terminal. Such as shown in FIG. 1, the scanner 2 mainly comprises a reading window 21, a keyboard 22, a customer display 23 for customer, a store clerk display 24 for store clerk, a buzzer 25 and an LED (Light Emitting Diode) 26.

When the commodity which can not be registered by the code symbol such as the barcode or the two-dimension code and the like is registered, the input is executed by various keys of a keyboard 22. The customer display 23 for customer is used for displaying the name, the price and the like of the registered commodity to the customer who goes shopping. The store clerk display 24 for store clerk is configured to display the name, the price and the like of the registered commodity to the operating store clerk.

The LED 26 is lightened to inform the operator that the hologram is read under the circumstance that the hologram is read. The buzzer 25 sends out a buzzer sound to inform the operator under the circumstance that the hologram is read.

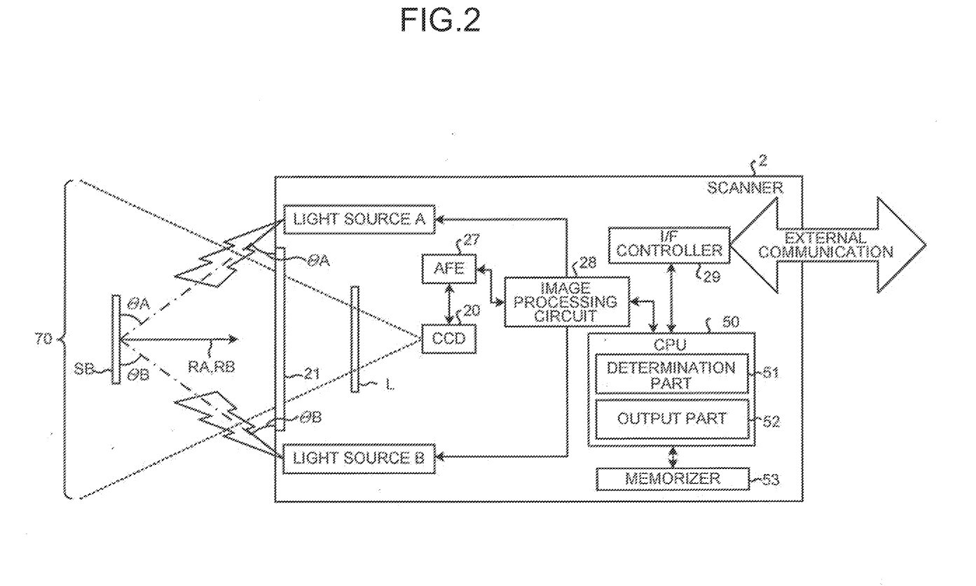

A CCD (Charge Coupled Device) 20 taken as an image pickup device is disposed in the scanner 2 which is provided with the reading window 21 (such as shown in FIG. 2). Furthermore, the image pickup device can use the other modes such as a CMOS (Complementary Metal Oxide Semiconductor) and the like. The CCD 20 pickups the imaging subject Sb (such as shown in FIG. 2) such as the commodity, the card, the voucher and the like put in an image pickup area 70 (such as shown in FIG. 2) which is opposite to the reading window 21.

And then, the hardware structure of the scanner 2 is illustrated. FIG. 2 is a block diagram showing the hardware structure of the scanner 2. The scanner 2 comprises a light source A, a light source B, a lens L, a CCD 20, an AFE 27 (Analog Front End) formed by an analog circuit, an image processing circuit 28, an I/F (Interface) controller 29, a CPU (Central Processing Unit) 50 and a memorizer 53.

The light source A and the light source B respectively consist of the LED (Light Emitting Diode) and the like and are controlled by the image processing circuit 28 to send out a pulsed light. Furthermore, such as shown in FIG. 2, the light source A and the light source B respectively illuminate the light towards the image pickup area 70 at an illuminating angle theta a and an illuminating angle theta b. Therefore, the light from the light source A is illuminated into the imaging subject Sb at the illuminating angle theta a, and the light from the light source B is illuminated into the imaging subject Sb at the illuminating angle theta b.

The image processing circuit 28 is taken as the control unit, the light source A and the light source B alternately send out the pulsed light.

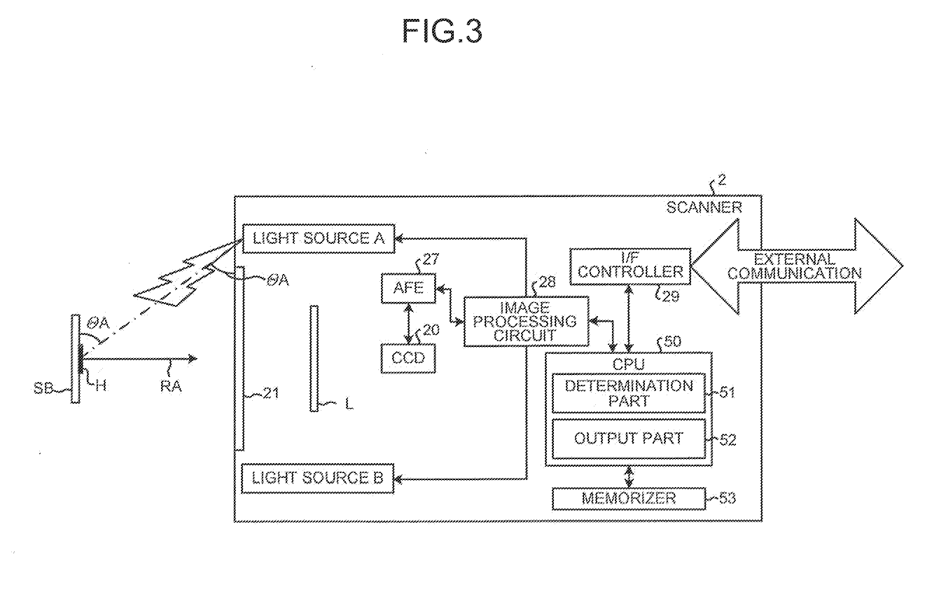

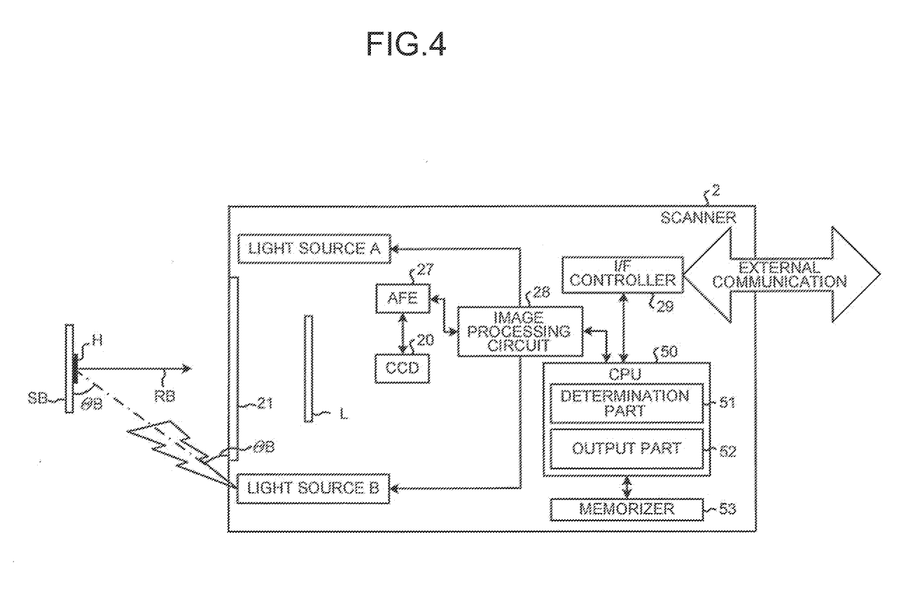

FIG. 3 and FIG. 4 are respectively to be an explanatory drawing showing the illuminating action of the light source A and the light source B. The light source B such as shown in FIG. 4 sends out the light at a set pulse number after the light source A such as shown in FIG. 3 of the image processing circuit 28 sends out the light at a set pulse number, so that the light source A and the light source B alternately send out the light every the set pulse number. Therefore, the image processing circuit 28 synchronously changes the illuminating angles and the pulsed luminescence of the light illuminated to the image pickup area 70 and alternately switches the illuminating angles (theta a and theta b) of the light illuminated to the imaging subject Sb. Furthermore, the image processing circuit 28 can switch the light source A and the light source B to illuminate every a set time.

Therefore, a reflecting light Ra and a reflecting light Rb which correspond to each illuminating angle can be changed to reflect by change the illuminating angles (theta a and theta b) of the light illuminated to the hologram H contained in the imaging subject Sb (such as shown in FIG. 3 and FIG. 4). And then, the reflecting light Ra and the reflecting light Rb are condensed by the lens L to image on a light receiving component of the CCD 20 and input the output of the CCD 20 to the image processing circuit 28 through the AFE 27.

The image processing circuit 28 comprises an amplifying circuit for amplifying an analog signal or a digital signal, an A/D (Analog to Digital) conversion circuit for converting the analog/digital and the like (which are not shown in Figures). Furthermore, the image processing circuit 28 amplifies the analog signal input by the CCD 20 by the amplifying circuit and executes the analog/digital conversion by the A/D conversion circuit. Furthermore, the image processing circuit 28 executes various images by the digital signal captured by means of analog/digital conversion.

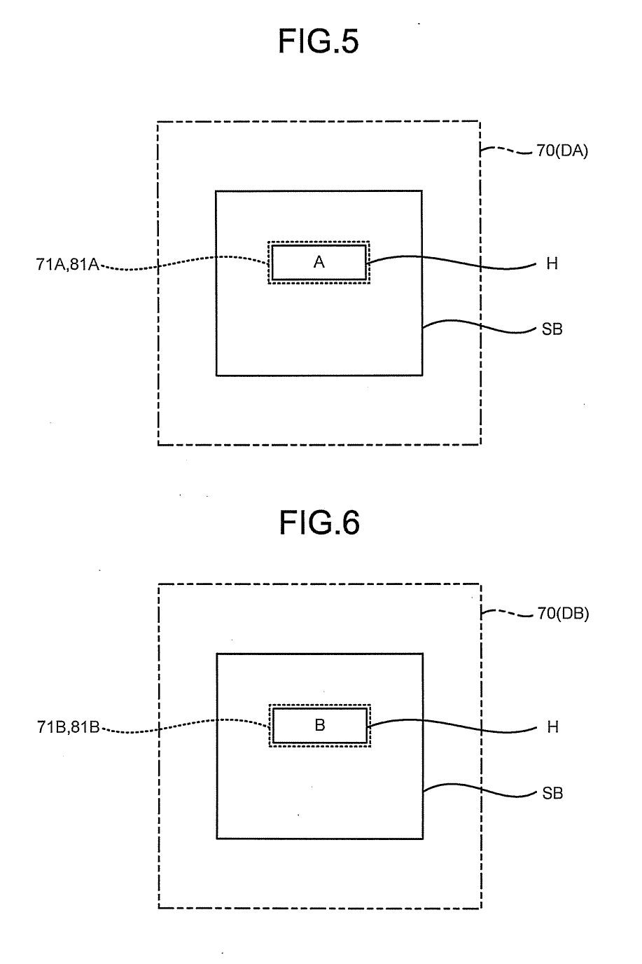

The image processing circuit 28 is taken as the image capturing unit to memorize an image DA (such as shown in FIG. 5) and an image DB (such as shown in FIG. 6) of the image pickup area 70 in the memorizer 53 corresponding to the change of the illuminating angle of the light.

Next, the image capturing action executed by the image processing 28 is described below. Furthermore, as one example, the circumstance that the hologram H which stand out two different images according to the different illuminating angles is affixed to the imaging subject Sb is described.

FIG. 5 is a drawing showing an example of a picked-up image DA when an imaging subject Sb is illuminated by a light source A. Furthermore, FIG. 6 is a drawing showing an example of a picked-up image when an imaging subject Sb is illuminated by a light source B. Such as shown in FIG. 3, after the light source A sends out the light, the image area 71a of the hologram H is picked-up corresponding to the light illuminating angle theta a, so that the image ‘A’ is stood out such as shown in FIG. 5. On the other hand, such as shown in FIG. 4, after the light source B sends out the light, the image area 71b of the hologram H is picked-up corresponding to the light illuminating angle theta b, so that the image ‘B’ is stood out such as shown in FIG. 6.

Furthermore, the image processing circuit 28 captures the image DA such as shown in FIG. 5 to be taken as the image which corresponds to the illuminating angle theta a when the light source A sends out the light. Furthermore, the image processing circuit 28 captures the image DB such as shown in FIG. 6 to be taken as the image which corresponds to the illuminating angle theta b when the light source B sends out the light. Therefore, the image processing circuit 28 captures the images DA and DB with the pulsed luminescence of the light source A and the light source B synchronously.

Returning to FIG. 2, the I/F controller 29 controls the data communication between the bus and the POS terminal 3 (such as shown in FIG. 3).

The memorizer 53 memorizes various programs and the like for controlling the action of the CPU 50. Furthermore, the memorizer 53 temporarily memorizes the image captured by the image processing circuit 28. Furthermore, the memorizer 53 memorizes an identification pattern which is used for identifying the character, the illustration, the symbol and the like to identify the information. As the identification pattern, for example, the pattern and the like for identifying the character used in OCR (optical Character Reader) is memorized.

The CPU 50 controls the whole action of the scanner 2 by executing various programs memorized in the memorizer 53. Furthermore, the CPU 50 is taken as a determination part 51 and an output part 52 by executing the programs of the embodiment memorized in the memorizer 53 such as shown in FIG. 2.

The determination unit 51 configured to determine that the image include holographic image which is the area picked-up hologram, if at least two of images with different illuminating angles captured by the image capturing unit 28 are different from each other.

More concretely, the determination part 51 compares the image DA (such as shown in FIG. 5) with the image DB (such as shown in FIG. 6), which are captured by the image processing circuit 28, to determine whether the image DA and the image DB internally comprise the different image areas.

For example, in FIG. 5 and FIG. 6, the relative position of the image DA to the image area 71a is as the same as that of the image DB to the image area 71b. However, the image 81a of the image area 71a internally comprises the character (image) such as ‘A’, on the other hand, the image 81b of the image area 71b internally comprises the character (image) such as ‘B’, and the image 81a is different from the image 81b. Therefore, the determination part 51 determines that the image areas 71a and 71b are the area which pickups the hologram H which reflects the different images according to the different light illuminating angles and determines that the images DA and DB comprise the holographic images (images 81a and 81b).

Furthermore, in above illustration, the image areas 71a and 71b are the areas with the same relative position within the captured images IDA and DB, however, the relative position of the image DA to the image area 71a and the relative position of the image DB to the image area 71b need not be as the same strictly. For example, the error within several percent can be allowed to determine whether the image area 71 which is generally as the same internally comprises the different images.

On the other hand, the determination part 51 determines that the image DA and the image DB do not comprise the area for pickup the hologram H under the circumstance that the image DA is as the same as the image DB.

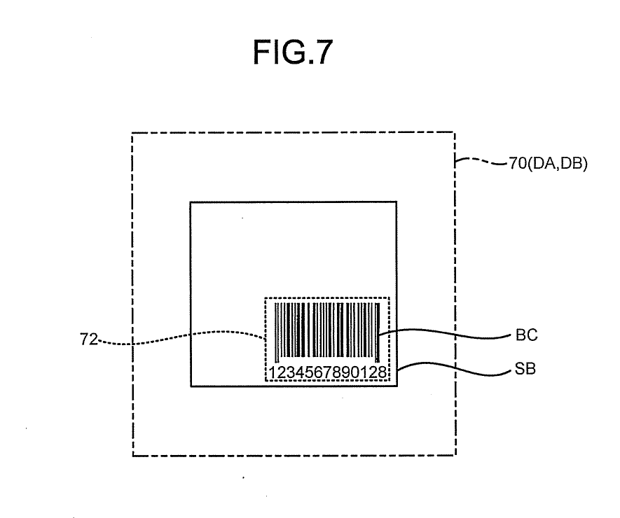

FIG. 7 is a drawing showing picked-up images DA and DB of a barcode BC illuminated by a light source A or a light source B. The image area 72 also comprises the same images where the same barcode BC is picked-up even if the light is illuminated by the light source A or the light source B under the circumstance that the imaging subject which is not as the hologram such as the barcode BC and the like is picked-up. That is to say, the image DA and the image DB are the same images. Therefore, the determination part 51 determines that the images DA and DB do not include the area picked-up the hologram H when the images DA and DB do not include the different image area.

The output part 52 outputs the image which is picked-up by changing the illuminating angle to the POS terminal 3 and the like through the I/F controller 29 and the transmission path which is not shown in figures. Furthermore, the output part 52 outputs the combination of a plurality of areas which pickup the same areas according to the different light illuminating angles (such as the combination of the image 81a and the image 81b) to be taken as the holographic image under the circumstance that the holographic image is picked-up such as in above illustration.

Furthermore, the output part 52 decodes the barcode BC, reads the commodity barcode, and outputs the barcode of the commodity to the POS terminal 3 under the circumstance that the images DA and DB do not include the barcode BC (such as shown in FIG. 7). Furthermore, the output part 52 reads the price-cut code and the like by the means that the pattern memorized in the memorizer 53 is identified and outputs the price-cut barcode and the like to the POS terminal 3 under the circumstance that the image such as the price-cut label and the like is further identified besides the barcode BC.

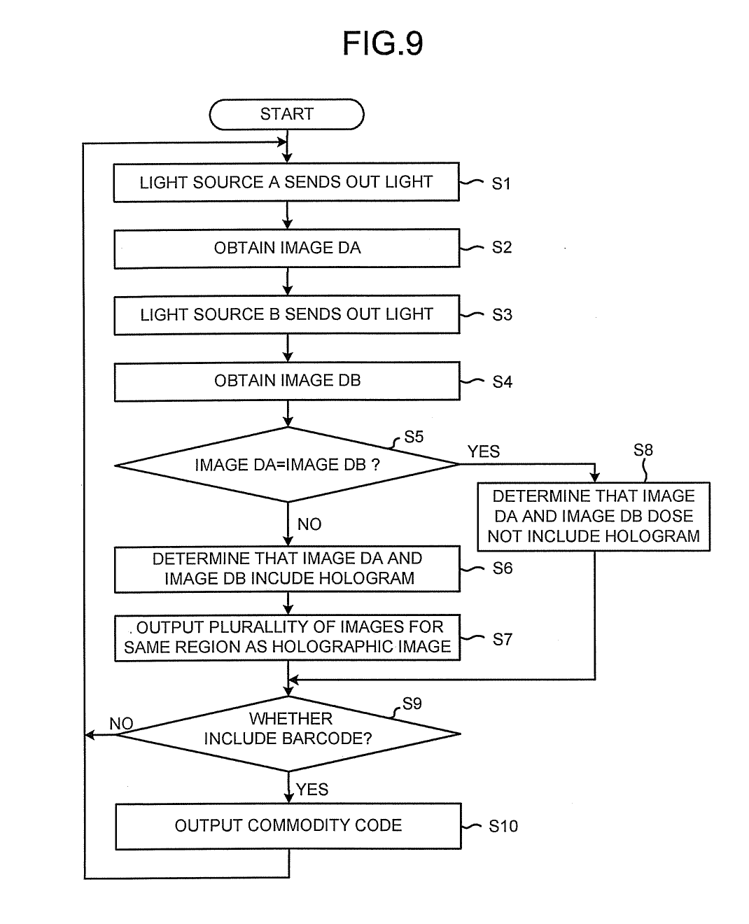

And then, the action example of the scanner 2 is illustrated. FIG. 9 is a flow chart showing the image capturing and processing sequence executed by a scanner.

The scanner 2 leads the light source A to send out the light at the set pulse number (Act S1). And then, the scanner 2 captures the image DA illuminated by the source A (Act S2).

And then, the scanner 2 leads the light source A to stop sending out the light, so that the light source B sends the light at the set pulse number (Act S3). And then, the scanner 2 captures the image DB illuminated by the source B (Act S4).

And then, the scanner 2 compares the image DA captured in the Act S2 with the image DB captured in the Act S4, and determines whether the image DA and the image DB are equal to one another (Act S5).

Under the circumstance that the image DA and the image DB do not include the different image areas, i.e. the image DA and the image DB are not equal to one another (Act S5: NO), the image DA and the image DB are determined to include the hologram (Act S6), the LED 26 is lightened, and the buzzer 25 buzzes. And then, scanner 2 takes the images of the same area as the holographic image to be output to the POS terminal 3 (Act S7) so as to turn to Act S9.

On the other hand, under the circumstance that the image DA and the image DB do not include the different image areas, i.e. the image DA and the image DB are equal to one another (Act S5: Yes), the image DA and the image DB are determined to not include the hologram (Act S8) so as to turn to Act S9.

The scanner 2 determines whether the image DA and the image DB include the barcode BC (Act S9). When the image DA and the image DB include the barcode BC (Act S9: Yes), the barcode of the commodity is decoded by the barcode BC and is output to the POS terminal 3 (Act S10). After the barcode of the commodity is output (Act S10), or when the image DA and the image DB do not include the barcode BC (Act S9 : No), the Act S1 is returned, and the processing of the Acts S1-S10 is repeated.

(The Other Embodiments for Changing the Illuminating Angles)

Furthermore, in above illustration, for example, two light sources A and B with different illuminating angles are set, but the number of the light sources with different illuminating angles can be more than 2. Furthermore, under the circumstance, for example, the plurality of light sources are set corresponding to the frame shape of the reading window 2b (such as shown in FIG. 1) and can be sequentially switched to send out the light.

Furthermore, in above illustration, the light illuminating angles are changed by the means that the light sources with different illuminating angles are switched to send out the light, however, the method for changing the illuminating angles can not be limited.

In the other examples, the light path is changed by disposing mirror and the like between at least one of the light sources and the image pickup area 70 and controlling the reflecting angle of the mirror to change the illuminating angles of the light to the image pickup area 70.

Furthermore, in the other examples, the light patch can be changed by disposing at least one of light sources of which the positions can be adjusted by an electric motor on the scanner 2 and changing the positions of the light sources to change the illuminating angles of the light to the image pickup area 70.

(For the Other Application of the Hologram)

Furthermore, in above illustration, the example of the hologram that two different images are stood out according to the different illuminating angles is illustrated, but the scanner 2 of the embodiment further can be used for the other holograms.

For example, the scanner 2 of the embodiment further can be used for the following holograms : the character or the symbol (such as ‘A’) is stood out when the light with the illuminating angle theta a is illuminated, and the character or the symbol is not stood out when the light without the illuminating angles except the illuminating angle theta a is illuminated. Under the circumstance, the scanner 2 stand outs the character or the symbol included in the hologram by changing the light illuminating angles.

Furthermore, the scanner 2 of the embodiment can be used for the hologram that at least two of different images are stood out by according to the change of the illuminating angles.

Therefore, the scanner 2 of the embodiment sends out the light by changing the illuminating angles of the image pickup area 70 of the CCD 20 and captures the image according to the change of the illuminating angles, so that the image of the holographic can be stood out, and the hologram can be identified. And then, the POS terminal 3 is described below. The POS terminal 3 is a sale data processor which is used for registering the commodity bought by the customer by the information input by the scanner 2 such as the barcode of the commodity and the like. Such as shown in FIG. 1, a keyboard 31, a displayer for operator (store clerk) 32, a displayer for customer 33, a printer 34 for printing receipt and the like, a cash drawer 35 for accepting cash and the like are disposed on the POS terminal 3. A cash total key for executing the registration that the commodity sale of one transaction is ended and the settlement of the commodity bill is disposed on the keyboard 31.

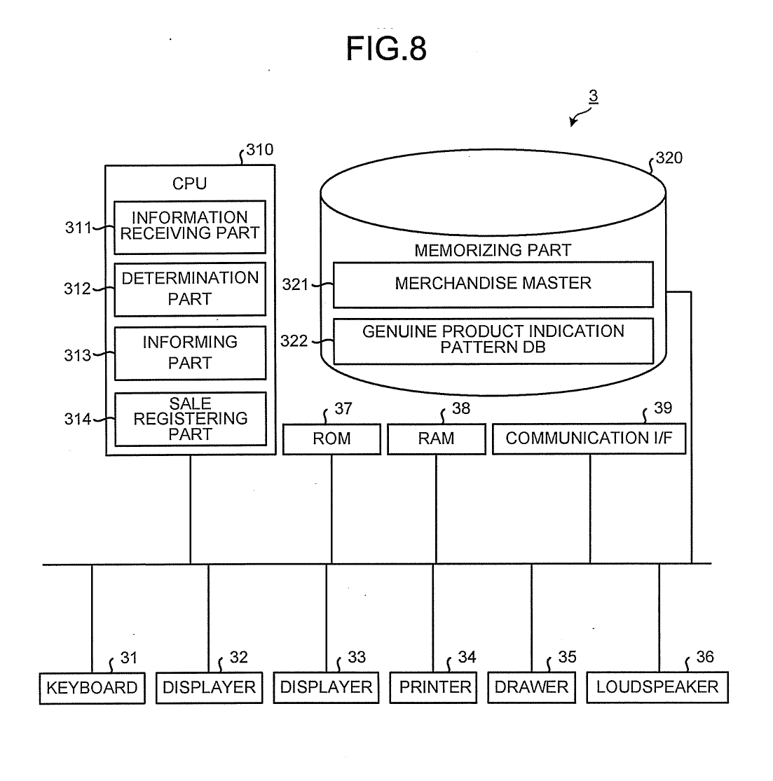

FIG. 8 is a block diagram showing the hardware structure of a POS (Point-of-Sale) terminal 3. Such as shown in FIG. 8, the POS terminal comprises a controller such as a CPU 310 and the like, a memorizer such as a ROM 37 or a RAM 38 and the like, and a communication I/F 39 for the communication with the scanner 2. Furthermore, the CPU 310 is connected with the keyboard 31, the displayer 32 for store clerk, the displayer 33 for customer, the printer 34, the drawer 35, a loudspeaker 36 and a memorizing part 320 such as an HDD (Hard Disk Drive), etc. These parts can be controlled by the means that the CPU 310 executes a program memorized in the ROM 37. The displayer 32 for store clerk is used for displaying a registering menu and the like used for registering the sale of the commodity.

The memorizing part 320 memorizes a merchandise master 321 and a genuine product indication pattern DB (data base) 322. The merchandise master 321 and the commodity code memorize the information of the commodity such as the name of the commodity, the section of the commodity, the price of the commodity, etc. The genuine product indication pattern DB 322 memorizes a pattern image of the genuine product indication included in the holographic image. More specifically, as the pattern image of the genuine product indication, the combination of different pattern images included in one holographic image is memorized. For example, about the hologram H that the different pattern images ‘A’ and ‘B’ are stood out according illuminating angle, as the combination of the pattern images of the genuine product indication included in the hologram H, the pattern images ‘A’ and ‘B’ are combined and memorized.

Such as shown in FIG. 8, the CPU 310 develops and executes the program read from the ROM 37 in the RAM 38 to be taken as the information receiving part 311, the determination part 312, the informing part 313 and the sale registering part 314.

The information receiving part 311 receives various data from the scanner 2 such as the commodity code, the price-cut barcode, the holographic image (such as the combination of the image 81a and image 81b) and the like through the communication I/F 39 and the transmission path which is not shown in figures.

The determination part 312 determines whether the holographic image is the reasonable genuine product indication by checking the pattern image of the genuine product indication memorized in the genuine product indication pattern DB 322 against the holographic image received from the scanner 2.

Generally speaking, the determination part 312 determines that the holographic image is the reasonable genuine product indication under the circumstance that the holographic image received by the information receiving part 311 is memorized in the genuine product indication pattern DB 322.

For example, the determination part 312 identifies the pattern of the combination of the image 81a (such as shown in FIG. 5) and the image 81b (such as shown in FIG. 6) by the combination of the pattern images memorized in the genuine product indication pattern DB 322. Furthermore, the determination part 312 determines that the holographic image is the reasonable genuine product indication under the circumstance that the combination of the pattern ‘A’ included in the image 81a and the pattern ‘B’ included in the image 81b is memorized in the genuine product indication pattern DB 322.

Furthermore, the determination part 312 determines that the holographic image is not the reasonable genuine product indication under the circumstances that the combination of the pattern image for one hologram is not memorized in the genuine product indication pattern DE 322 and the degree of coincidence of the pattern image is not arrive at a set threshold value, etc.

The informing part 313 informs that the holographic image is counterfeit by the means of display output, sound output and the like under the circumstance that the determination part 312 determines that the holographic image is not the reasonable genuine product indication. For example, the informing part 313 displays an error message such as ‘the authentication errors of the genuine product indication’ and the like to the displayer 32 for store clerk and the displayer 33 for customer, outputs an error sound to the loudspeaker 36, and informs that the holographic image is counterfeit.

The sale registering part 314 provisional registers the commodity by the commodity code input from the scanner 2. Furthermore, the provisional registration comprises the following proceeding of: reading the commodity name and the commodity price which correspond to received commodity code from the merchandise master 321, and temporarily memorizing the commodity name and the commodity price in a work memorizer of the RAM 38 as the commodity information of the commodity sold to the customer.

The sale registering part 314 displays the commodity name and the commodity price which are provisional registered on the registering menu of the displayer 32 for store clerk and the displayer 33 for customer. Furthermore, when the cash total key of the keyboard 31 is pressed, the sale registering part 314 ends the reception of the commodity code input of one transaction and determines the sale registering of the commodity which is provisional registered.

Furthermore, the sale registering part 314 does not register the commodity of the commodity code which relates to the holographic image under the circumstance that the determination part 312 determines that the holographic image is not the reasonable genuine product indication. Furthermore, the method which relates the holographic image to the commodity code is not particularly limited, in below the action example that relates the holographic image to the commodity code which received just before receiving the holographic image is illustrated.

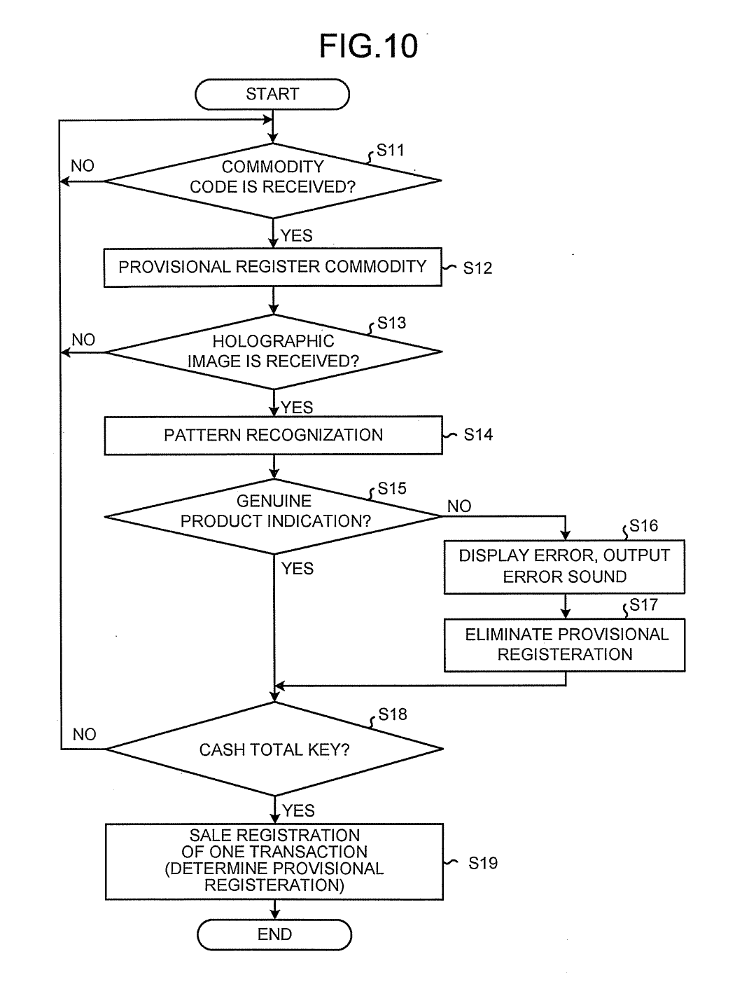

And then, the action example of the POS terminal 3 is illustrated. FIG. 10 is a flow chart showing the sale registering and processing sequence executed by a POS (Point-of-Sale) terminal 3.

Firstly, the information receiving part 311 determines whether the commodity code is received from the scanner 2 (Act S11). The Act S11 is returned to Act S11 to wait for the input under the circumstance that the commodity code is not received (Act S11: No). The sale registering part 314 provisional registers the commodity by the commodity code such as in above illustration (Act 12) under the circumstance that the commodity code is received (Act S11: Yes).

And then, the information receiving part 311 determines whether the holographic image (i.e. the combination of different images within the same image area) is received from the scanner 2 (Act S13). If the circumstance that the holographic image is not received (Act S13: No), return to Act S11 and wait for the nest input of the commodity code (Act S11).

Under the circumstance that the holographic image is received (Act S13: Yes), the determination part 312 pattern recognize the combination of the holographic image received in Act S13 by using the combination of the pattern images of the genuine product indication memorized in the genuine product indication pattern DB 322 (Act S14), and determines whether the holographic image is the reasonable genuine product indication (Act S15).

Under the circumstance that holographic image is genuine product indication (Act S15; Yes), turn to Act S18. Under the circumstance that holographic image is not genuine product indication (Act S15; No), the informing part 313 displays the error message such as ‘the authentication errors of the genuine product indication’ and the like on the displayer 32 for store clerk and the displayer 33 for customer and outputs the error sound to the loudspeaker 36 (Act S16). Furthermore, the sale registering part 314 eliminates the provisional registration of the commodity of the commodity code received in the Act S11 (Act S17). Furthermore, the sale registering part 314 displays the content that the provisional registration of the commodity is eliminated on the registering menu displayed on the displayer 32 for store clerk and the displayer 33 for customer (Act S17).

In Act S18, the sale registering part 314 determines whether the cash total key of the keyboard 31 is pressed and the transaction is ended (Act S18). Under the circumstance that the cash total key is not pressed (Act S18: No), return to Act S11 and the input acceptance of the commodity code is repeated as the above description, till that the cash total key is pressed (Act S11-stpe S18). Under the circumstance that the cash total key is pressed (Act S18: Yes), the sale registering of the commodity which is provisional registered is determined to end the sale register of one transaction (Act S19).

As mentioned, above, the POS terminal 3 of the embodiment can determine whether the card, the note, the voucher and the like are the genuine product indication by the holographic image output from the scanner 2.

Furthermore, the present invention is not limited by the embodiments, and the deformation of the constituting components is materialized in the scope without departing from the major idea at the implementation phase. Furthermore, various inventions can be formed by the means that the constituting components disclosed by the embodiments are properly combined with each other. For example, the constituting components can be eliminated from the whole constituting components shown in the embodiment. Furthermore, the constituting components in different embodiments can be combined with each other properly.

For example, in above illustration, in order to identify the price-cut label and the like, the pattern for identifying the character is memorized in the memorizer 53, however, the pattern can be memorized not in the memorizer 53 but in the memorizing part 320 of the POS terminal 3 to identify the pattern by the CPU 310 of the POS terminal 3. Furthermore, in above illustration, the pattern of the holographic image is identified by the determination part 312 of the POS terminal 3, but also the pattern can be identified by the CPU 50 of the scanner 2.

Furthermore, in above illustration, the informing part 313 can be used for informing the error, but the informing part 313 can be further used for informing the content of the reasonable genuine product indication. For example, under the circumstance that the determination part 312 determines that the hologram is the reasonable product indication, the informing part 313 displays the message such as ‘the genuine product indication is verified’ and the like on the displayer 32 for store clerk and the displayer 33 for customer, and the loudspeaker 36 outputs a determine sound to inform the content of the holographic image is the reasonable genuine product.

Furthermore, in above illustration, the method used for relate the commodity code just before receiving the holographic image to the holographic image, but the method of the relating the holographic image to the commodity code is not particularly limited. For another example, it can relate the commodity code received just after receiving the holographic image to the holographic image. Or, the commodity barcode of the commodity affixed with the holographic image can be provisional memorized in the memorizing part 320 of the POS terminal 3, and the holographic image can relate to the commodity code with reference to the memorizing part 320.

Furthermore, for example, the sale registering part 314 also can register the voucher and the membership card according to a determination result of the determination part 312 under the circumstance that the genuine product indication of the voucher and the membership card is executed service by the voucher, the membership card, etc.

For example, the sale registering part 314 can not accept the price input of the voucher which relates to the holographic image under the determination that the holographic image affixed on the voucher is not the genuine product indication. Furthermore, the sale registering part 314 does not execute the service such as the price-cut promotion or point addition and the like by production of membership card relate to the holographic image under the circumstance that the holographic image affixed on the membership card is not genuine product indication.

Furthermore, the program executed by the scanner 2 and the POS terminal 3 of the embodiment, can be structured such as memorized in a record medium which can be read by the computer such as the CD-ROM, the flexible disk (FD), the CD-R,, the DVD (Digital Versatile Disk) and the like, which is the file of the installable form or the executable form and provided. Furthermore, the program executed by the scanner 2 and the POS terminal 3 of the embodiment, can be memorized in the computer connected with the network such as the internet and the like and provided by mean of the network loading. Furthermore, the program executed by the scanner 2 of the embodiment, can be provided or published via the network such as the internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A scanner, comprising:
an image pickup unit;
a light source configured to illuminate the light to an image pickup area of the image pickup unit for pickup the image;
a control unit configured to change the illuminating angles of the light illuminated to the image pickup area;
an image capturing unit configured to capture the image of the image pickup area by changing the illuminating angles; and
an output unit configured to output the image with the different illuminating angles captured by the image capturing unit.

2. The scanner according to claim 1, further comprising:
a determination unit configured to determine that the image include holographic image which is the area picked-up hologram, if at least two of images with different illuminating angles captured by the image capturing unit are different from each other.

3. The scanner according to claim 1, wherein
the light source is set up as a plurality light sources that the illuminating angles to the image pickup area are different from each other; and
the control unit changes the illuminating angles of the light by switching the light sources.

4. The scanner according to claim 2, wherein
the light source is set up as a plurality light sources that the illuminating angles to the image pickup area are different from each other; and
the control unit changes the illuminating angles of the light by switching the light sources.

5. The scanner according to claim 1, wherein
the light sources emit pulsed light;
the control unit is synchronous with the emission of the pulsed light to change the illuminating angle of the light; and
the imaging capturing unit is synchronous with the emission of the pulsed light to capture at least two of images with different illuminating angles.

6. The scanner according to claim 2, wherein
the light sources emit pulsed light;
the control unit is synchronous with the emission of the pulsed light to change the illuminating angle of the light; and
the imaging capturing unit is synchronous with the emission of the pulsed light to capture at least two of images with different illuminating angles.

7. The scanner according to claim 3, wherein
the light sources emit pulsed light;
the control unit is synchronous with the emission of the pulsed light to change the illuminating angle of the light; and
the imaging capturing unit is synchronous with the emission of the pulsed light to capture at least two of images with different illuminating angles.

8. The scanner according to claim 4, wherein
the light sources emit pulsed light;
the control unit is synchronous with the emission of the pulsed light to change the illuminating angle of the light; and
the imaging capturing unit is synchronous with the emission of the pulsed light to capture at least two of images with different illuminating angles.

9. A sale data processor, comprising:
a receiving unit configured to receive the holographic image outputted from the scanner according to claim 1; and
an informing unit configured to inform the error, if the holographic image received by the receiving unit is not memorized in a memorizing part which memorizes a pattern image included in the holographic image.

10. The sale data processor according to claim 9, wherein
the receiving unit configured to receive the commodity code from the scanner; and further comprising:
a sale registering unit configured to register the commodity sale of the commodity code if the holographic image received by the receiving unit is memorized in the memorizing part, and not to register the commodity sale of the commodity code if the holographic image received by the receiving unit is not memorized in the memorizing part.
